(19) United States
(12) Patent Application Publication
(10) Pub. No.: US 2009/0246313 A1
(43) Pub. Date: Oct. 1, 2009

(54) MOLD FIXING STRUCTURE

(75) Inventor: KENG-MING CHANG, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/237,599

(22) Filed: Sep. 25, 2008

(30) Foreign Application Priority Data
Mar. 28, 2008 (CN) 200810300750.5

(51) Int. Cl. B29C 45/32

(52) U.S. Cl. 425/588

(57) ABSTRACT

A mold fixing structure includes a top mold unit and a bottom mold unit. The top and bottom mold units cooperatively define a pouring passage. The top mold unit includes a top mold base, a top mold sleeve, and a top mold insert. The bottom mold unit includes a bottom mold base, a bottom mold sleeve, and a bottom mold insert. Each top and bottom mold unit defines a molding chamber communicating with the pouring passage. Each top and bottom mold sleeve defines a mold cavity for receiving the corresponding mold insert. The bottom mold sleeve includes an engaging protrusion. The bottom mold sleeve includes an engaging groove matched with the engaging protrusion. The engaging protrusion is aligned with and engaged in the engaging groove. Each top and bottom mold base defines a fixing hole. The top and bottom mold sleeves are detachably mounted in the fixing holes.

### BACKGROUND

1. Technical Field

The present invention generally relates to mold structures, and particularly to a mold fixing structure for insert molding.

2. Description of Related Art

Referring to FIG. 7, a typical mold fixing structure 7 includes a top mold unit 71 and a bottom mold unit 72 attached to the top mold unit 71. The top mold unit 71 includes a top mold base 711, two top mold inserts 712, and a top fixing plate 713. The top mold base 711 defines two top mold cavities 714 and two holes 715 extending therethrough. The top mold inserts 712 are inserted into the top mold cavities 714 from top to bottom. The top fixing plate 713 is positioned on the top surface of the top mold base 711, preventing the top mold inserts 712 from moving axially within the top mold cavities 714. Similarly, the bottom mold unit 72 includes a bottom mold base 721, two bottom mold inserts 722 and a bottom fixing plate 723. The bottom mold base 721 defines two bottom mold cavities 724 extending therethrough. The bottom mold inserts 722 are inserted into the bottom mold cavities 724 from bottom to top, respectively. Two pins 725 upwardly extend from the bottom mold base 721, and are inserted into the holes 715 of the top mold base 71 to align the top mold inserts 712 with the bottom mold inserts 722. The bottom fixing plate 723 is positioned on the bottom of the bottom mold base 721, preventing the bottom mold inserts 722 from moving axially within the bottom mold cavities 724.

However, deviations are still formed between the holes 715 and the pins 725. When the holes 715 and the pins 725 have different deviation extents and deviation directions, the top mold inserts 712 will not precisely align with the bottom mold inserts 722, which negatively impacts the quality of the molding product. In addition, the top (bottom) mold base 711 (721) needs to be disassembled to be replaced or repaired when one of the top mold cavities 714 and bottom mold cavities 724 is damaged, which increases the manufacturing cost of the mold fixing structure 7.

What is needed, therefore, is a mold fixing structure which can overcome the above-mentioned disadvantages.

### SUMMARY

A mold fixing structure includes a top mold unit and a bottom mold unit. The top and bottom mold units cooperatively define a pouring passage. The top mold unit includes a top mold base, a top mold sleeve, and a top mold insert. The bottom mold unit includes a bottom mold base, a bottom mold sleeve, and a bottom mold insert. Each top and bottom mold unit defines a molding chamber communicating with the pouring passage. Each top and bottom mold sleeve defines a mold cavity for receiving the corresponding mold insert. The bottom mold sleeve includes an engaging protrusion. The bottom mold sleeve includes an engaging groove matched with the engaging protrusion. The engaging protrusion is aligned with and engaged in the engaging groove. Each top and bottom mold base defines a fixing hole. The top and bottom mold sleeves are detachably mounted in the fixing holes.

Other advantages and novel features of the present invention will become more apparent from the following detailed description when taken in conjunction with the accompanying drawings.

### BRIEF DESCRIPTION OF THE DRAWINGS

Many aspects of the present mold fixing structure can be better understood with reference to the following drawings. The components in the drawings are not necessarily drawn to scale, the emphasis instead being placed upon clearly illustrating the principles of the present mold fixing structure. Moreover, in the drawings, like reference numerals designate corresponding parts throughout the several views.

FIG. 1 is an assembled, isometric view of one embodiment of a mold fixing structure, the mold fixing structure including a top mold unit and a bottom mold unit.

FIG. 2 is an exploded, isometric view, showing the bottom mold unit of the mold fixing structure of FIG. 1.

FIG. 3 is an isometric, cross-sectional view of a bottom mold sleeve of the mold fixing structure of FIG. 2.

FIG. 4 is an exploded, isometric view, showing the top mold unit of the mold fixing structure of FIG. 1

FIG. 5 is an isometric, cross-sectional view of a top mold sleeve of the mold fixing structure of FIG. 4.

FIG. 6 is a cross-sectional view of the mold fixing structure of FIG. 1, taken along line VI-VI.

FIG. 7 is an exploded, cross-sectional isometric view of a typical mold fixing structure.

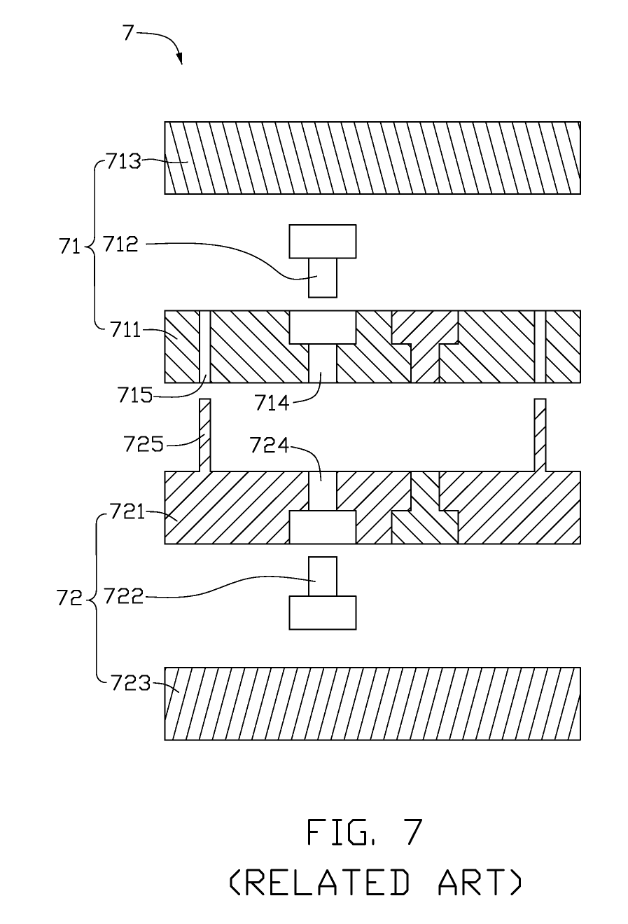

### DETAILED DESCRIPTION OF THE EMBODIMENTS

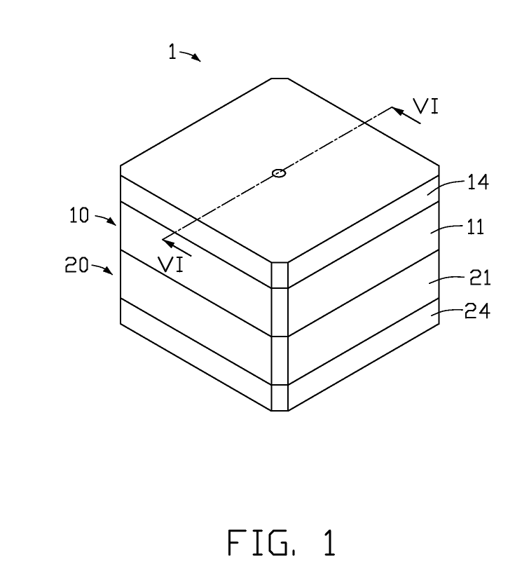

Referring to FIG. 1, a mold fixing structure 1 includes a top mold unit 10 and a bottom mold unit 20 attached to the top mold unit 10.

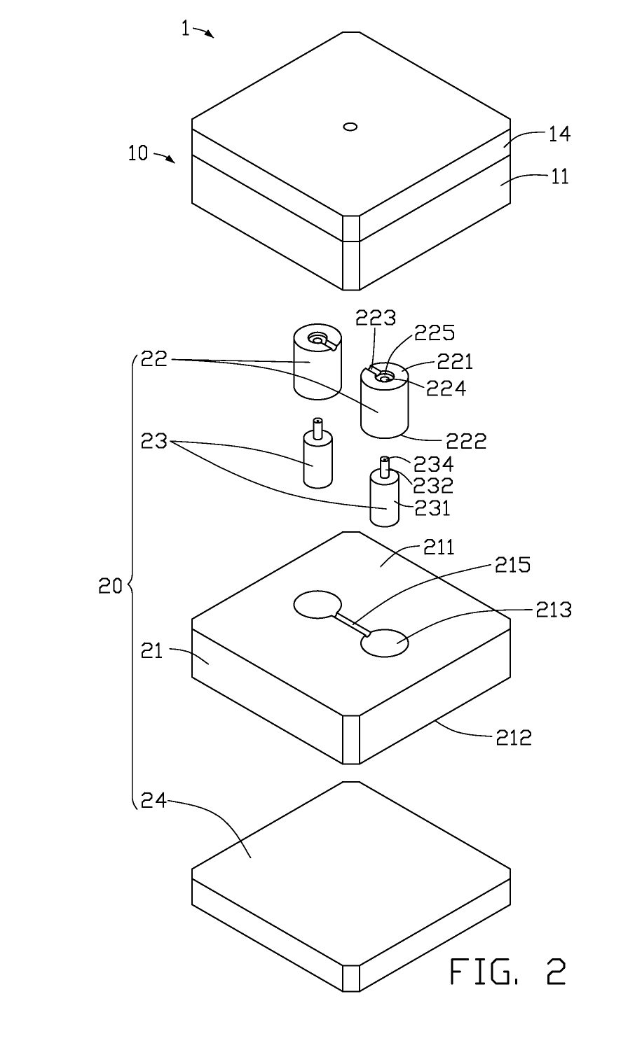

Referring to FIG. 2, the bottom mold unit 20 includes a bottom mold base 21, two bottom mold sleeves 22, two bottom mold inserts 23, and a bottom fixing plate 24.

The bottom mold base 21 is a rectangular block, and includes a contacting surface 211 and a fixing surface 212 opposite to the contacting surface 211. The bottom mold base 21 defines two fixing holes 213 extending perpendicularly through the contacting surface 211 and the fixing surface 212, to receive the bottom mold sleeves 22. The contacting surface 211 of the bottom mold base 21 defines a sub-pouring channel 215 communicating with the fixing holes 213.

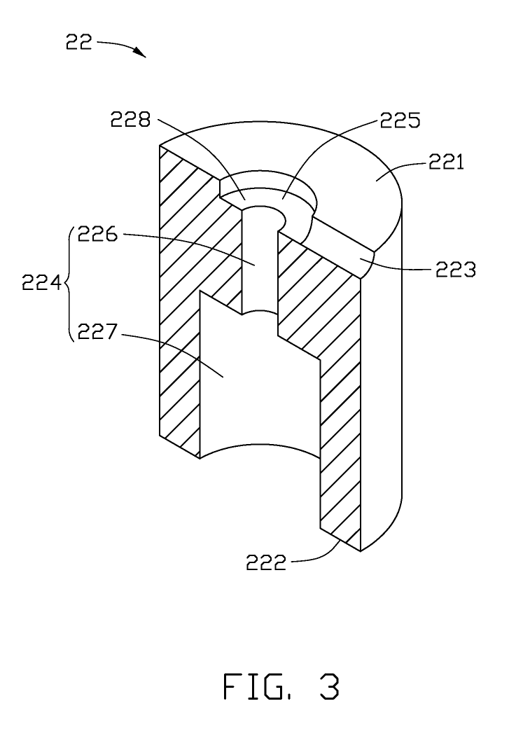

Referring to FIG. 3, the cylindrical bottom mold sleeves 22 are female mold sleeves. Each of the bottom mold sleeves 22 has a diameter slightly greater than a diameter of each of the fixing hole 213, so that each of the bottom mold sleeves 22 is interferentially engaged in each of the fixing holes 213. Each of the bottom mold sleeves 22 has a top surface 221 and a bottom surface 222 opposite to the top surface 221. Each of the bottom mold sleeves 22 defines a feeding groove 223 in the top surface 221. The feeding grooves 223 correspond with the sub-pouring channels 215. When each of the bottom mold sleeves 22 is fixed into the corresponding fixing hole 213, the top surface 221 is coplanar with the contacting surface 211, and the bottom surface 222 is coplanar with the fixing surface 212.

Each of the bottom mold sleeves 22 further defines a mold cavity 224 and a cylindrical engaging groove 225 communicating with the mold cavity 224. The mold cavity 224 includes a cylindrical first cavity 226 and a cylindrical second cavity 227 coaxial to the first cavity 226. The first cavity 226 communicates with the engaging groove 225. The second cavity 227 is adjacent to the bottom surface 222. A diameter of the first cavity 226 is less than that of the second cavity 227. The engaging groove 225 is adjacent to the top surface 221. The engaging groove 225 has a diameter greater than a diameter of the first cavity 226 of the mold cavity 224. A parting face 228 is defined at a bottom end of the engaging groove 225. The engaging groove 225 communicates with the feeding groove 223, and has a same depth as a depth of the feeding groove 223. In other words, a bottom most point of the feeding groove 223 is coplanar with the parting face 228.

Referring to FIG. 2, the bottom mold inserts 23 are configured for inserting into the mold cavities 224. Each of the bottom mold inserts 23 includes a main body 231 and an extension portion 232 extending perpendicularly from the main body 231. The shape and size of the main body 231 and the extension portion 232 correspond to the shape and size of the first cavity 226 and the second cavity 227. The extension portion 232 defines a molding chamber 234 at a top end thereof for molding a product. The molding chamber 234 may have various shapes according to different molding products.

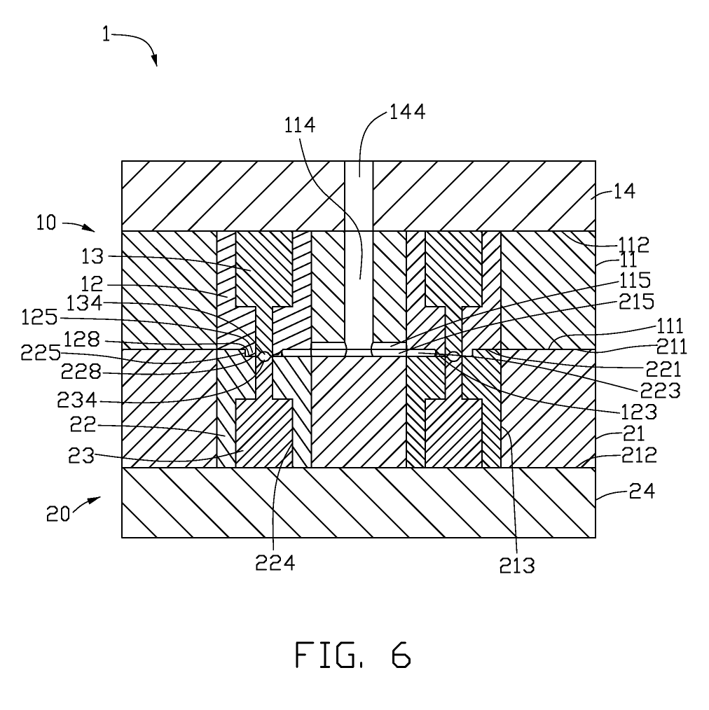

The bottom fixing plate 24 is a rectangular block. The bottom fixing plate 24 is positioned on the fixing surface 212 of the bottom mold base 21 (shown in FIG. 6), further preventing the bottom mold sleeves 22 and the bottom mold inserts 23 from moving axially within the bottom mold cavities 224 of the bottom mold base 21.

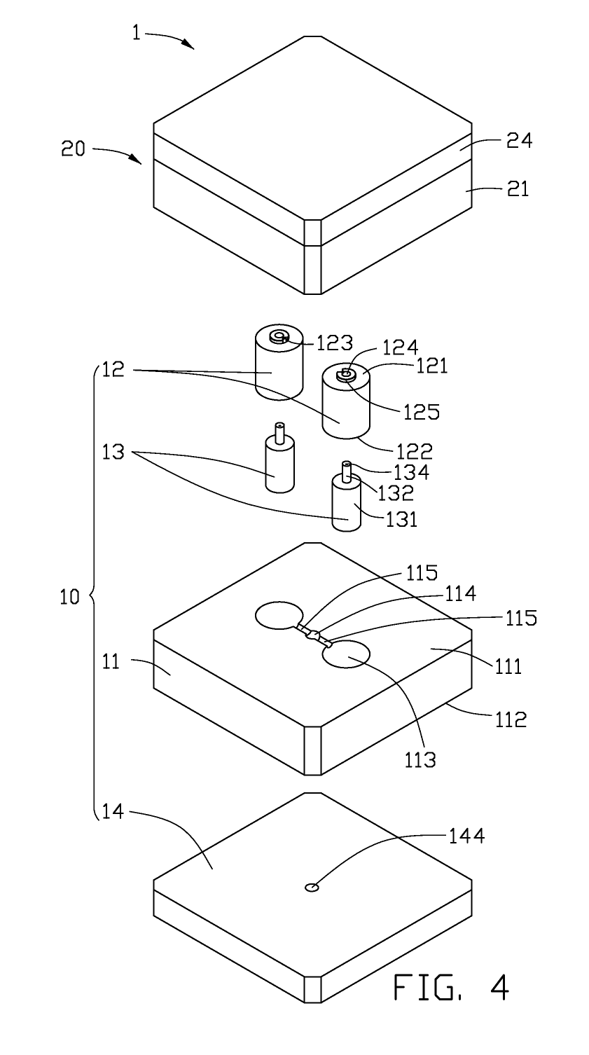

Referring to FIG. 4, the top mold unit 10 is similar to the bottom mold unit 20. The top mold unit 10 includes a top mold base 11, two top mold sleeves 12, two top mold inserts 13, and a top fixing plate 14.

The top mold base 11 is similar to the bottom mold base 21. The top mold base includes a contacting surface 111, a fixing surface 112, two fixing holes 113, and a sub-pouring channel 115. The difference between the top mold base 11 and the bottom mold base 21 is that the top mold base 11 defines a main pouring channel 114 extending perpendicularly through the contacting surface 111 and the fixing surface 112. The main pouring channel 114 is located between the two fixing holes 113, and communicates with the sub-pouring channel 115. A cross-sectional area of the main pouring channel 114 is greater than a cross sectional area of the sub-pouring channel 115.

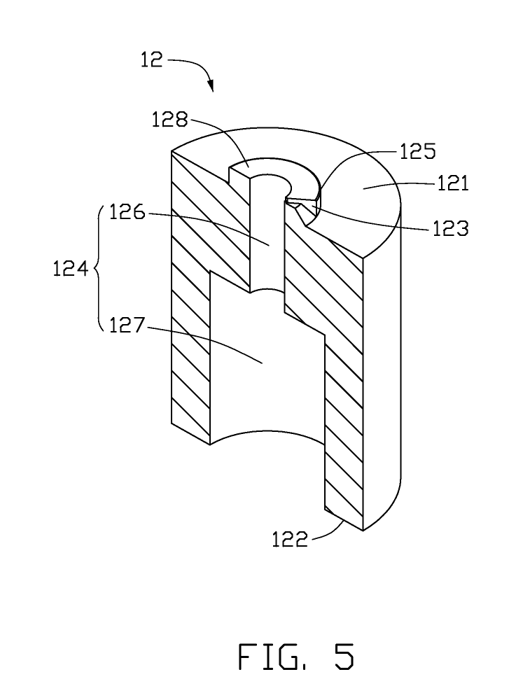

Referring to FIG. 5, the top mold sleeves 12 are male mold sleeves corresponding to the bottom mold sleeves 22. Each of the top mold sleeves 12 has a top surface 121 and a bottom surface 122 opposite to the top surface 121. When each of the top mold sleeves 12 is fixed into the corresponding fixing hole 113, the top surface 121 is coplanar with the contacting surface 111, and the bottom surface 122 is coplanar with the fixing surface 112.

Each of the top mold sleeves 12 includes an engaging protrusion 125 and a mold cavity 124. The engaging protrusion 125 extends perpendicularly from the top surface 121, and is received in the engaging groove 225. A height of the engaging protrusion 125 is substantially equal to a depth of the mold cavity 124. The engaging protrusion 125 includes a parting face 128 at a top end thereof. Each of the top mold sleeves 12 defines a feeding opening 123 in the parting face 128. The feeding opening 123 communicates with the mold cavity 124. In one embodiment, a depth and a width of the feeding opening 123 decrease from outside towards the mold cavity 124 along a radial direction. Accordingly, a cross-sectional area of the feeding opening 123 reduces from outside towards the mold cavity 124. An inner end of the feeding opening 123 is smaller than an outer end of the feeding opening 123 such that molded material in the inner end of the feeding opening 123 is smaller than molded material in the outer end of the feeding opening 123. Thus, the molding product can separate easily from the feeding opening 123 and the sub-pouring channel 115 when opening the mold. In another embodiment, either the depth or the width of the feeding opening 123 may reduce from outside towards the mold cavity 124.

The mold cavity 124 also includes a cylindrical first cavity 126 and a cylindrical second cavity 127 coaxial to the first cavity 126 and communicating with the first cavity 126. The first cavity 126 is adjacent to the top surface 121, and communicates with the feeding opening 123. The second cavity 127 is adjacent to the bottom surface 122. A diameter of the first cavity 126 is less than a diameter of the second cavity 127.

Referring to FIG. 4, the top mold inserts 13 are similar to the bottom mold inserts 23. The top mold inserts 13 can be received in the mold cavities 124 of the top mold sleeves 12. Each of the top mold inserts 13 also includes a main body 131 and an extension portion 132. The extension portion 132 also defines a molding chamber 134 at a top end thereof for molding the product. The molding chamber 134 may have various shapes according to the different molding products. In another embodiment, either the molding chamber 134 of the top mold insert 13 or the molding chamber 234 of the bottom mold insert 23 can be omitted.

The top fixing plate 14 is similar to the bottom fixing plate 24. The difference between the top fixing plate 14 and the bottom fixing plate 24 is that the top fixing plate 14 defines a feeding channel 144 extending through from a top surface to a bottom surface. The feeding channel 144 communicates with the main pouring channel 114 to allow the molded material to enter into the main pouring channel 114.

Referring to FIG. 6, during assembly, the bottom mold sleeves 22 are detachably mounted in the fixing holes 213 of the bottom mold base 21. The top surfaces 221 of the bottom mold sleeves 22 are coplanar with the contacting surface 211 of the bottom mold base 21, and the feeding grooves 223 of the bottom mold sleeves 22 communicate with the sub-pouring channel 215 of the bottom mold base 21. The bottom mold inserts 23 are inserted into the mold cavities 224 of the bottom mold sleeves 22 from bottom to top. The bottom fixing plate 24 is fixed on the fixing surface 212 of the bottom mold base 21. Similarly, the top mold unit 10 can be assembled according to the manner assembling the bottom mold unit 20.

The top mold unit 10 is positioned together with the bottom mold unit 20. The engaging protrusions 125 of the top mold sleeves 12 are aligned and inserted into the engaging grooves 225 of the bottom mold sleeves 22. The top surface 121 and the parting face 128 of each top mold sleeve 12 contact the top surface 221 and the parting face 228 of each bottom mold sleeve 22. The contacting surface 111 of the top mold base 11 contacts the contacting surface 211 of the bottom mold base 21. The molding chamber 134 of each top mold insert 13 communicates with the molding chamber 234 of the corresponding bottom mold insert 23 to cooperatively form a new molding chamber for molding the product. The feeding openings 123 of the top mold sleeves 12, and the main pouring channel 114 and the sub-pouring channel 115 of the top mold base 11 communicate with the feeding grooves 223 of the bottom mold sleeves 22 and the sub-pouring channel 215 of the bottom mold base 21 to cooperatively form a new pouring passage. The pouring passage allows the molded material for molding the product to enter into the molding chamber.

In the mold fixing structure 1, the engaging protrusions 125 of the top mold sleeves 12 are aligned with and engaged in the engaging grooves 225 of the bottom mold sleeves 22. Thus, the mold fixing structure 1 can be precisely fixed according to the cooperation of the top mold sleeves 12 and bottom mold sleeves 22. In addition, each pair of mold sleeves includes a top mold sleeve 12 and a corresponding bottom mold sleeve 22 that can be fixed and the mold product molded separately. In other words, one pair of mold sleeves can not intervene in another pair of mold sleeves. Thus, the deviations resulted from the typical holes and pins having different deviation extents and deviation directions can be reduced, which improves the quality of the molding product. Furthermore, when one of the mold cavities 124, 224 of the top, bottom mold sleeves 12, 22 is damaged, only the damaged mold cavity needs to be disassembled to replace or repair the mold cavities 124, 224. Thus, there is no need to replace or repair the top and bottom mold bases 11, 21, which reduces the manufacturing cost of the mold fixing structure 1.

In one embodiment of the mold fixing structure 1, the feeding openings 123, the main pouring channel 114, the sub-pouring channel 115, the feeding grooves 223, and the sub-pouring channel 215 cooperatively form a new pouring passage. In another embodiment, the pouring passage can only be formed in either the top mold unit 10 or the bottom mold unit 20.

It is believed that the embodiments and its advantages will be understood from the foregoing description, and it will be apparent that various changes may be made thereto without departing from the spirit and scope of the embodiments or sacrificing all of its material advantages, the examples hereinbefore described merely being preferred or exemplary embodiments of the invention.

What is claimed is:

1. A mold fixing structure for molding a product, comprising:
a first mold unit comprising:
a first mold base defining a first fixing hole therein;
a first mold sleeve detachably mounted in the first fixing hole, the first mold sleeve defining an engaging groove and a mold cavity; and
a first mold insert received in the mold cavity of the first mold sleeve;
a second mold unit comprising:
a second mold base defining a second fixing hole therein, wherein the second mold base is attached to the first mold base;
a second mold sleeve detachably mounted in the second fixing hole, the second mold sleeve comprising an engaging protrusion extending therefrom and defining a mold cavity, the engaging protrusion being aligned with and engaged in the engaging groove; and
a second mold insert received in the mold cavity of the second mold sleeve;
wherein at least one of the first and second mold inserts define a molding chamber adapted for molding the product; the first and second mold units cooperatively define a pouring passage communicating with the molding chamber.

2. The mold fixing structure of claim 1, wherein the mold cavity of the first mold sleeve communicates with the engaging groove, and the mold cavity of the second mold sleeve extends through the engaging protrusion.

3. The mold fixing structure of claim 1, wherein the mold cavity of the first mold sleeve and the mold cavity of the second mold sleeve each comprises a first cavity and a second cavity having a diameter greater than a diameter of the first cavity, the first and second cavities of the first mold sleeve are coaxial to the engaging groove, the first and second cavities of the second mold sleeve are coaxial to the engaging protrusion; the first and second mold inserts each comprises a main body received in the second cavity and an extension portion received in the first cavity.

4. The mold fixing structure of claim 1, wherein the first mold sleeve defines a feeding groove communicating with the engaging groove and the mold cavity of the first mold sleeve; the engaging protrusion defines a feeding opening communicating with the mold cavity of the second mold sleeve.

5. The mold fixing structure of claim 4, wherein a cross-sectional area of the feeding opening decreases from outside towards the mold cavity.

6. The mold fixing structure of claim 4, wherein the first mold base defines a sub-pouring channel; the second mold base defines a sub-pouring channel and a main pouring channel; the feeding groove, the sub-pouring channel and the main pouring channel of the first mold base communicating with the feeding opening of the second mold sleeve and the sub-pouring channel of the second mold base to cooperatively form the pouring passage.

7. The mold fixing structure of claim 1, further comprising a first fixing plate fixed on the first mold base and a second fixing plate fixed on the second mold base, the first fixing plate defines a feeding channel communicating with the pouring passage.

8. The mold fixing structure of claim 1, wherein the first mold sleeve has a diameter slightly greater than a diameter of the first fixing hole, the first mold sleeve interferentially engages with the first fixing hole; the second mold sleeve has a diameter slightly greater than a diameter of the second fixing hole, the second mold sleeve interferentially engages with the second fixing hole.

9. A mold fixing structure for molding a product, comprising:
two mold units attached to each other, each of the mold units comprising:
a mold base defining a fixing hole;
a mold sleeve detachably mounted in the fixing hole, and comprising a mold cavity; and
a mold insert received in the mold cavity,
wherein a first of the mold sleeves comprises an engaging groove, and a second of the mold sleeves comprises an engaging protrusion corresponding with the engaging groove; the engaging protrusion is aligned with and engaged in the engaging groove; at least one of the mold inserts define a molding chamber adapted for molding the product; at least one of the mold units defines a pouring passage communicating with the molding chamber.

10. The mold fixing structure of claim 9, wherein the mold cavity of the first of the mold sleeves communicates with the engaging groove; the mold cavity of the second of the mold sleeves extends through the engaging protrusion.

11. The mold fixing structure of claim 9, wherein the mold cavity of the first of the mold sleeves is coaxial to the engaging groove, the mold cavity of the second of the mold sleeves is coaxial to the engaging protrusion.

12. The mold fixing structure of claim 9, wherein the first of the mold sleeve defines a feeding groove communicating with the engaging groove and the mold cavity of the second of the mold sleeves; the engaging protrusion defines a feeding opening communicating with the mold cavity of the second mold sleeve.

13. The mold fixing structure of claim 12, wherein a cross-sectional area of the feeding opening decreases from outside towards the mold cavity of the first of the mold sleeves.

14. The mold fixing structure of claim 12, wherein a first of the mold bases defines a sub-pouring channel, and a second of the mold bases defines a sub-pouring channel and a main pouring channel; the feeding opening, the main pouring channel, and the sub-pouring channels communicating with the feeding groove to cooperatively form the pouring passage.

15. The mold fixing structure of claim 9, further comprising two fixing plates respectively fixed on the mold bases, one of the fixing plates defining a feeding channel communicating with the pouring passage.

16. The mold fixing structure of claim 9, wherein each of the mold sleeves has a diameter slightly greater a diameter of each of the fixing holes, the mold sleeves interferentially engage with the fixing holes.
